(19) United States
(12) Patent Application Publication
(10) Pub. No.: US 2014/0172735 A1
(43) Pub. Date: Jun. 19, 2014

(54) GUARANTEED SHIPPING COST

(71) Applicants: Sarada Prasanna Jena, Cupertino, CA (US); Sanjay Narang, Foster City, CA (US)

(72) Inventors: Sarada Prasanna Jena, Cupertino, CA (US); Sanjay Narang, Foster City, CA (US)

(73) Assignee: eBay Inc., San Jose, CA (US)

(21) Appl. No.: 13/720,768

(22) Filed: Dec. 19, 2012

(51) Int. Cl. G06Q 10/08

(52) U.S. Cl. CPC G06Q 10/08345
USPC 705/330

(57) ABSTRACT

A system and method for a guaranteed shipping cost are described. A guaranteed shipping cost qualification module determines whether an item to be listed by a seller in an online marketplace qualifies for a guaranteed shipping cost listing. An estimated shipping cost computation module computes an estimated shipping cost of the item. A shipping cost reconciliation module reconciles an accrual of the estimated shipping cost received from the buyer with an actual shipping cost received from a shipping service provider for shipping the item. A learning module adjusts the estimated shipping cost computation module based on the reconciliation between the estimated shipping cost and the actual shipping cost.

### TECHNICAL FIELD

This application relates generally to the field of computer technology, and in a specific example embodiment, to a method and system for providing a guaranteed shipping cost in an electronic marketplace.

### BACKGROUND

Online marketplaces include many sellers listing items for sale. Buyers buy these items and sellers ship the item to the buyer upon receipt of payment. The shipping process typically includes the seller packing the item in a box, sealing it up, bring it to the post office, filling out the necessary forms, weighing it to calculate the postage, paying for the postage, affixing the stamp on the box, and finally dropping the box in the parcel deposit area. Because this inefficient shipping process entails many steps, it becomes a deterrent for sellers to list, sell, and ship their items. Furthermore, many sellers are unable to provide an exact quote of shipping cost for an item.

### BRIEF DESCRIPTION OF THE DRAWINGS

The present invention is illustrated by way of example, and not by way of limitation, in the figures of the accompanying drawings in which:

FIG. 1 is a network diagram depicting a network system, according to one embodiment, having a client-server architecture configured for exchanging data over a network.

FIG. 2 shows a block diagram illustrating one example embodiment of a publishing application.

FIG. 3 shows a block diagram illustrating one example embodiment of a guaranteed shipping cost application.

FIG. 4 shows a ladder diagram illustrating one example embodiment of a process for shipping an item using the guaranteed shipping cost application.

FIG. 5 shows a flow diagram illustrating one example embodiment of a method for generating a list with a guaranteed shipping cost.

FIG. 6 shows a flow diagram illustrating one example embodiment of a method for operating the guaranteed shipping cost application.

FIG. 7 shows a flow diagram illustrating another example embodiment of a method for reconciling the actual shipping cost and the guaranteed shipping cost.

FIG. 8 shows a diagrammatic representation of machine in the example form of a computer system within which a set of instructions may be executed to cause the machine to perform any one or more of the methodologies discussed herein.

### DETAILED DESCRIPTION

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

A system and method for a guaranteed shipping cost are described. A guaranteed shipping cost qualification module determines whether an item to be listed by a seller in an online marketplace qualifies for a guaranteed shipping cost listing. An estimated shipping cost computation module computes an estimated shipping cost of the item. A shipping cost reconciliation module reconciles an accrual of the estimated shipping cost received from the buyer with an actual shipping cost received from a shipping service provider for shipping the item. A learning module adjusts the estimated shipping cost computation module based on the reconciliation between the estimated shipping cost and the actual shipping cost.

In particular, consumer to consumer sellers (C2C) are daunted by the inability to estimate shipping costs when listing an item, which results, in low C2C sell volume on the site. The system described in the present disclosure estimates and guarantees the shipping cost estimate for preselected or predefined supported item categories for C2C sellers. This encourages buyers to just provide the item cost and standard item related descriptions to list an item. The shipping costs are “guaranteed” only when the sellers print a shipping label using the present system for select services from shipping service providers.

### System Architecture

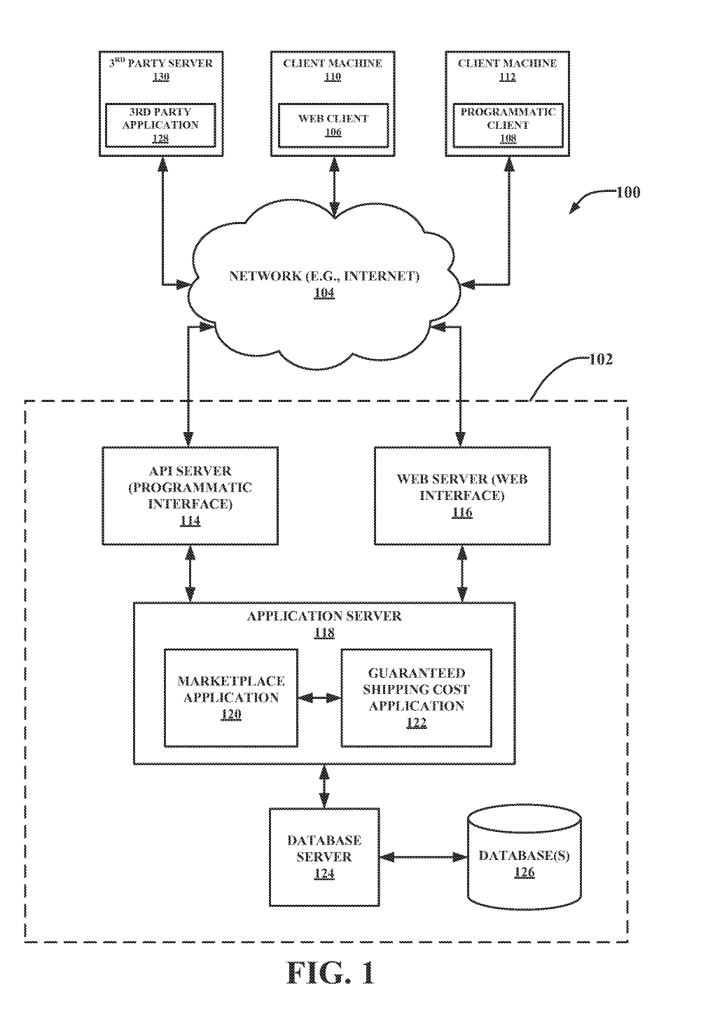

FIG. 1 is a network diagram depicting a network system 100, according to one embodiment, having a client-server architecture configured for exchanging data over a network. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture as an example, other embodiments may include other network architectures, such as a peer-to-peer or distributed network environment.

A data exchange platform, in an example form of a marketplace application 120 and a guaranteed shipping cost application 122, may provide server-side functionality, via a network 104 (e.g., the Internet) to one or more clients. The one or more clients may include users that utilize the network system 100 and more specifically, the marketplace application 120 and the guaranteed shipping cost application 122, to exchange data over the network 104. These transactions may include transmitting, receiving (communicating) and processing data to, from, and regarding content and users of the network system 100. The data may include, but are not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data such as collection and payment, shipping transactions, shipping label purchases, and real time synchronization of financial journals, among others.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third party server 130 with a third party application 128. It can be appreciated that in various embodiments the client machines 110, 112, or third party server 130 may be associated with a buyer, a seller, a third party electronic commerce platform, a payment service provider, a shipping service provider, or a financial institution system, each in communication with the network-based publisher 102 and optionally each other. The buyers and sellers may be any one of individuals, merchants, or service providers, among other things.

Turning specifically to the marketplace application 120 and the guaranteed shipping cost application 122, an application program interface (API) server 114 and a web server 116 are coupled to, and provide programmatic and web interfaces respectively to, one or more application servers 118. The application server 118 hosts one or more marketplace applications 120 and the guaranteed shipping cost application 122. The application server 118 is, in turn, shown to be coupled to one or more database servers 124 that facilitate access to one or more database(s) 126,

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or third party server 130).

In one embodiment, the marketplace application 120 provides listings and price-setting mechanisms whereby a user may be a seller or buyer who lists or buys goods and/or services (e.g., for sale) published on the marketplace application 120.

In one embodiment, the guaranteed shipping cost application 122 includes a system and a method for generating and activating dormant shipping labels to a shipper or a seller of the marketplace application 120.

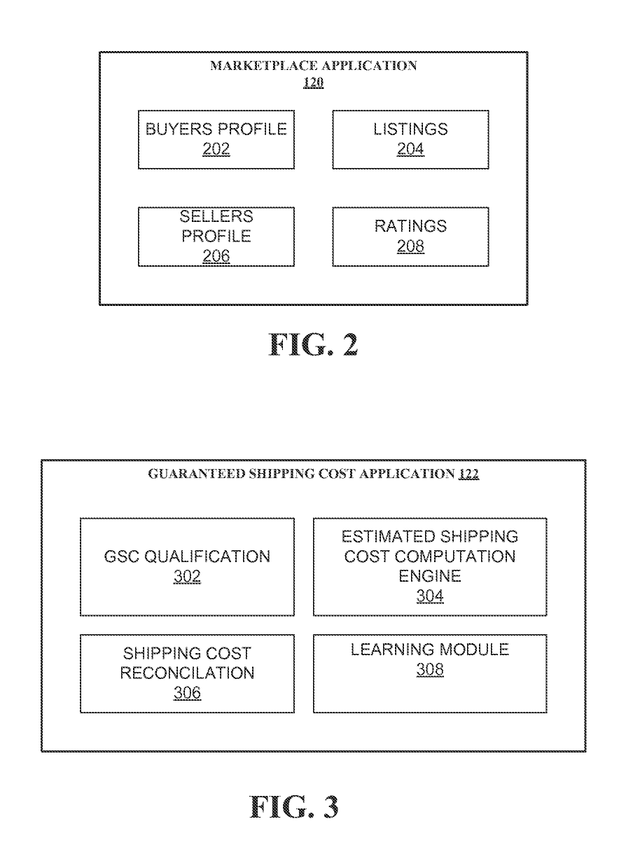

FIG. 2 shows a block diagram illustrating one example embodiment of the marketplace application 120. The marketplace application 120 includes, for example, a buyers profile module 202, a sellers profile module 206, a listings module 204, and a ratings module 208.

The buyers profile module 202 may be configured to generate and store profiles of buyers of the marketplace application 120. For example, the profiles of the buyers may include names, addresses (including shipping address), and transaction history.

The sellers profile module 206 may be configured to generate and store profiles of sellers of the marketplace application 120. For example, the profiles of the seller may include names, addresses (including shipping address), and transaction history.

The listings module 204 may be configured to generate and store listings from the sellers. The listings may identify items for sale in the marketplace application 120.

The ratings module 208 may be configured to generate and store ratings, including feedback ratings of buyers and sellers. In another embodiment, the ratings module 208 may also be configured to generate transaction volume and shipping volume on the marketplace application 120, or any other online marketplace.

FIG. 3 shows a block diagram illustrating one example embodiment of the guaranteed shipping cost application 122. The guaranteed shipping cost application 122 may include a guaranteed shipping cost qualification module 302, an estimated shipping cost computation engine 304, a shipping cost reconciliation module 306, and a learning module 308. In one embodiment, an online marketplace application may generate the guaranteed shipping cost listing comprising a listing from the seller for the item with the estimated shipping cost of the item as a firm shipping cost of the item for the seller. The online marketplace may generate a financial transaction between the seller and a buyer for the item in the guaranteed shipping cost listing, accrue a first portion of the financial transaction for the estimated shipping cost, and accrue a second portion of the financial transaction for the seller.

The guaranteed shipping cost qualification module 302 may determine whether an item listed by a seller, and the seller qualify for a guaranteed shipping cost program where the shipping cost is guaranteed, or set firm to the seller. In one embodiment, the guaranteed shipping cost qualification module 302 determines whether an item to be listed by a seller in an online marketplace qualifies for a guaranteed shipping cost listing. For example, a seller may qualify for the guaranteed shipping cost program if they are sellers who sell more than a predetermined number of transactions (e.g., 20) on the online marketplace per month. Furthermore, the item may qualify for the guaranteed shipping cost program if it corresponds to a predefined category of items such as small electronics. For example, it is easier for the guaranteed shipping cost program to estimate the shipping cost of a small electronic item with a known brand than a large piece of furniture of unknown origin.

In another embodiment, the guaranteed shipping cost qualification module 302 is configured to qualify the item for the guaranteed shipping cost listing if the item is listed in a list of items with predictable shipping costs without requesting a weight of the item from the seller.

In another embodiment, based on the seller transaction history or other online behavioral data (for non-members), the seller may receive a promotional email or view a banner ad advertising ‘Guaranteed Shipping Cost’ (GSC) from the online marketplace. The setter may click on the link where they see a short, relevant program message and a link to start listing on the online marketplace using the guaranteed shipping cost program. Once the seller qualifies and enrolls for the GSC program, all the seller needs to provide are the item specifics and the cost that they expect to get from the sale. If the item is eligible or can be supported by GSC, then in the “Shipping section,” the shipping service may defaulted to ‘LISPS priority mail’ with a message, for example, “Guaranteed by eBay.”

The estimated shipping cost computation engine 304 computes an estimated shipping cost of the item. For example, the estimated shipping cost computation engine 304 calculates the flat shipping cost for US domestic buyers. In one embodiment, the estimated shipping cost computation engine 304 computes the estimated shipping cost of the item based on a history of previous transactions involving the same item in the online marketplace. The shipping cost computation engine may also compute the estimated shipping cost of the item as a flat shipping cost regardless of destination using the shipping service provider. In another embodiment, the estimated shipping cost computation engine generates a shipping label to be used with the shipping service provider.

The shipping cost reconciliation module 306 reconciles an accrual of the estimated shipping cost received from the buyer with an actual shipping cost received from a shipping service provider for shipping the item. In one embodiment, the shipping cost reconciliation module 306 determines a difference between the estimated shipping cost and the actual shipping cost. For example, eBay may have estimated and received $6.00 for shipping cost while the actual shipping cost at the Postal Office was $6.50. eBay does not bear a loss for $0.50 but instead increases the cost of some future shipping cost quote to recover the amount. (e.g., quoted amount for next 25 sellers goes ‘up’ by 2 cents). Similarly, if eBay makes a profit of $0.50, it spreads out this cost by lowering the cost of some future GSC quotes. (e.g., quoted amount for next 25 sellers goes ‘down’ by 2 cents).

The learning module 308 adjusts the estimated shipping cost computation module based on the reconciliation between the estimated shipping cost and the actual shipping cost. In one embodiment, the learning module 308 increases the estimated shipping cost for the item by the difference between the estimated shipping cost and the actual shipping cost when the actual shipping cost is higher than the estimated shipping cost. Conversely, the learning module 308 decreases the estimated shipping cost for the item by the difference between the estimated shipping cost and the actual shipping cost when the actual shipping cost is less than the estimated shipping cost.

### Example Scenario

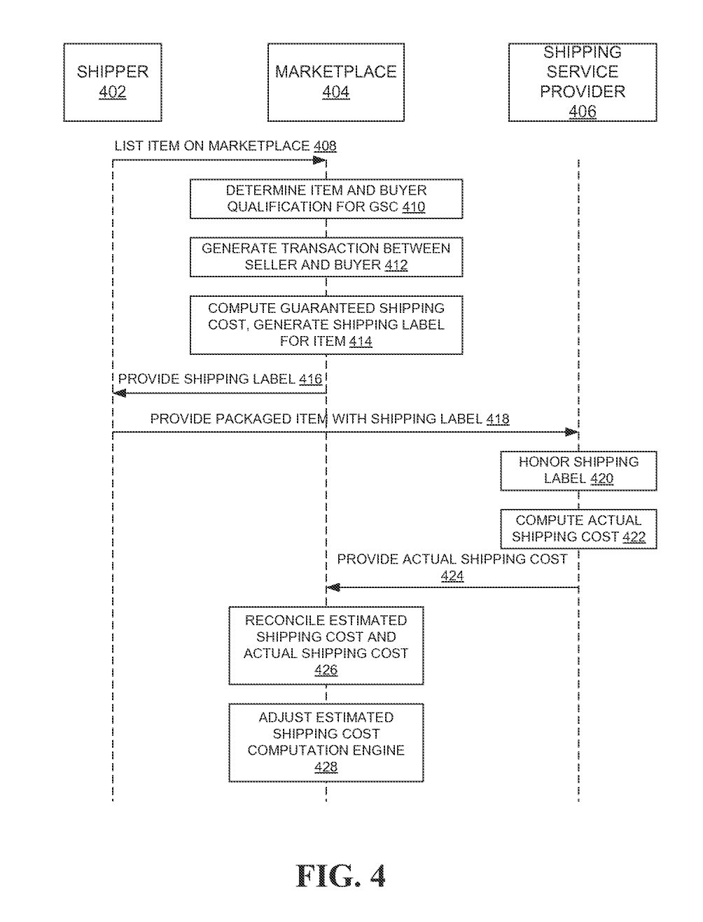

FIG. 4 illustrates an example of a guaranteed shipping cost system that enables a seller 402 to obtain a guaranteed shipping cost and a corresponding shipping label from a marketplace 404 to be used at a shipping service provider 406. At operation 408, the seller 402 may submit an item to be listed for sale on the marketplace 404.

At operation 410, the online marketplace 404 determines whether the item to be listed from the seller 402 qualifies for the guaranteed shipping cost program. For example, the online marketplace 404 determines whether the seller 402 is a frequent seller on the online marketplace 404. Furthermore, the online marketplace 404 determines whether the item to be listed corresponds to a category of item approved for the guaranteed shipping cost program.

At operation 412, the online marketplace 404 generates a transaction between the seller 402 and a buyer for the corresponding listed item.

At operation 414, the online marketplace 404 computes an estimated shipping cost to be used as the guaranteed shipping cost based on a description of the item. The online marketplace 404 may receive a financial transaction from the buyer in the amount of the listed item and the estimated shipping cost. At operation 416, the online marketplace 404 further generates a shipping label to the seller 402 for the item to see shipped to the buyer.

At operation 418, the seller 402 packages the item in a box and affixes the shipping label on the box. The seller 402 then brings the packaged item to the shipping service provider 406 (e.g., USPS, etc.).

At operation 420, the shipping service provider 406 honors the shipping label provided by the seller 402 and generated by the online marketplace 404. The shipping service provider 406 also computes the actual shipping cost at operation 422. The shipping service provider 406 then provides the actual shipping cost of the box at operation 424. In one embodiment, the shipping service provider 406 bills the online marketplace 404 for the actual shipping cost.

At operation 426, the online marketplace 404 reconciles the estimated shipping cost and the actual shipping cost. At operation 428, the online marketplace 404 adjusts, for future computation, the estimated shipping cost computation engine based on the difference between the estimated shipping cost and the actual shipping cost from operation 426. In other words, the online marketplace 404 includes a learning algorithm figured to further enhance the estimation of the shipping cost.

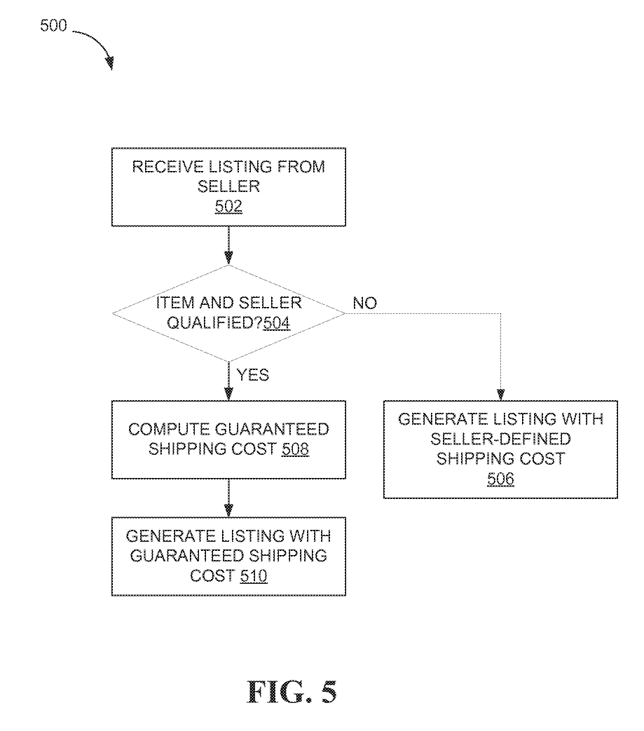

FIG. 5 shows a flow diagram illustrating one example embodiment of a method 500 for generating a list with a guaranteed shipping cost. At operation 502, a listing for an item for an online marketplace is received from a seller. At operation 504, the online marketplace determines whether the item and the seller qualify for the guaranteed shipping costs program. If the seller does not qualify for the guaranteed shipping cost program, the online marketplace generates a listing using a seller defined shipping cost at operation 506.

If the seller and the item do qualify for the guaranteed shipping cost program, the online marketplace computes a guaranteed shipping cost based on a description of the item at operation 508. At operation 510, the online marketplace generates a listing that displays the guaranteed shipping cost in the listing.

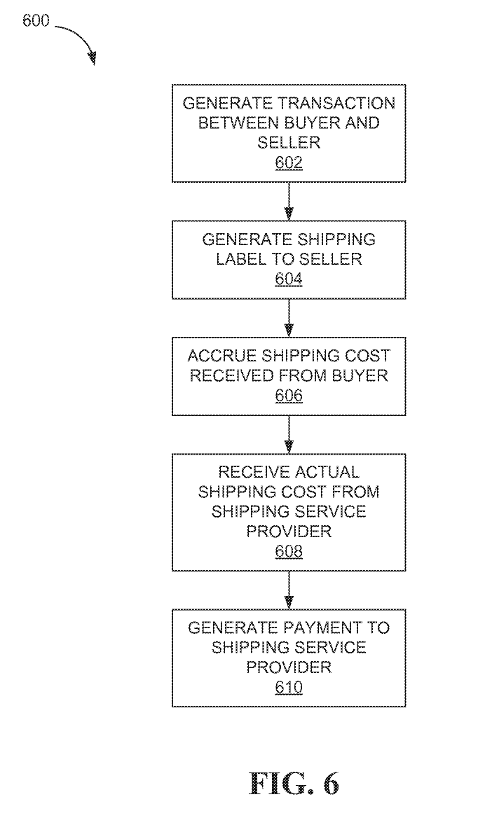

FIG. 6 shows a flow diagram illustrating one example embodiment of a method 600 for operating the guaranteed shipping cost application. At operation 602, the online marketplace generates a transaction between a buyer and the seller of the item. At operation 604, the online marketplace generates a shipping label to the seller for the guaranteed shipping cost. At operation 606, the online marketplace accrues the shipping cost received from the buyer. At operation 608, the online marketplace receives information of the actual shipping cost from the shipping service provider. At operation 610, the online marketplace generates a payment to the shipping service provider based on the actual shipping cost.

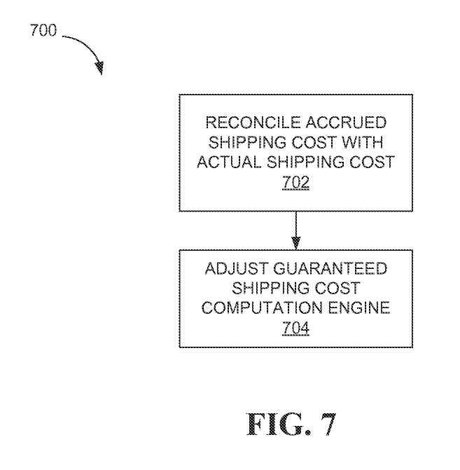

FIG. 7 shows a flow diagram illustrating another example embodiment of a method 700 for reconciling the actual shipping cost and the guaranteed shipping cost. At operation 702, the online marketplace reconciles the accrued estimated shipping cost with the actual shipping cost from the shipping service provider. At operation 704, the online marketplace adjusts the guaranteed shipping cost computation engine based on the reconciliation operation in operation 702.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein,

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Computer System

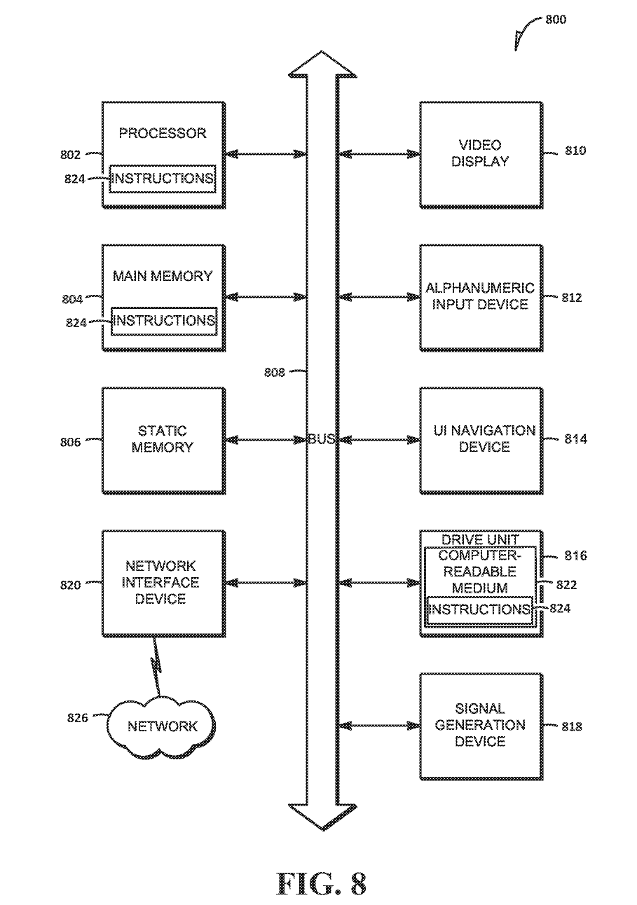

FIG. 8 shows a diagrammatic representation of a machine in the example form of a computer system 800 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a user interface (UI) navigation device 814 (e.g., a mouse), a disk drive unit 816, a signal generation device 818 (e.g., a speaker) and a network interface device 820.

The disk drive unit 816 includes a machine-readable medium 822 on which is stored one or more sets of instructions and data structures (e.g., software 824) embodying or utilized by any one or more of the methodologies or functions described herein. The software 824 may also reside, completely or at least partially, within the main memory 804 and/or within the processor 802 during execution thereof by the computer system 800, with the main memory 804 and the processor 802 also constituting machine-readable media.

The software 824 may further be transmitted or received over a network 826 via the network interface device 820 utilizing any one of a number of well-known transfer protocols (e.g., HTTP).

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed:

1. A guaranteed shipping cost system comprising:
at least one processor;
a guaranteed shipping cost qualification module, implemented with the at least one processor, configured to determine whether an item to be listed by a seller in an online marketplace qualifies for a guaranteed shipping cost listing;
an estimated shipping cost computation module, implemented with the at least one processor, configured to compute an estimated shipping cost of the item;
a shipping cost reconciliation module, implemented with the at least one processor, configured to reconcile an accrual of the estimated shipping cost received from the buyer with an actual shipping cost received from a shipping service provider for shipping the item; and
a learning module, implemented with the at least one processor, configured to adjust the estimated shipping cost computation module based on the reconciliation between the estimated shipping cost and the actual shipping cost.

2. The guaranteed shipping cost system of claim 1, further comprising:
an online marketplace application configured to generate the guaranteed shipping cost listing comprising a listing from the seller for the item with the estimated shipping cost of the item as a firm shipping cost of the item for the seller.

3. The guaranteed shipping cost system of claim 2, wherein the online marketplace is configured to generate a financial transaction between the seller and a buyer for the item in the guaranteed shipping cost listing, to accrue a first portion of the financial transaction for the estimated shipping cost, and to accrue a second portion of the financial transaction for the seller.

4. The guaranteed shipping cost system of claim 1, wherein the guaranteed shipping cost qualification module is configured to qualify the item for the guaranteed shipping cost listing if the item is listed in a list of items with predictable shipping costs without requesting a weight of the item from the seller.

5. The guaranteed shipping cost system of claim 1, wherein the estimated shipping cost computation engine is configured to compute the estimated shipping cost of the item based on a history of previous transactions involving the same item in the online marketplace.

6. The guaranteed shipping cost system of claim 1, wherein the estimated shipping cost computation engine is configured to compute the estimated shipping cost of the item as a flat shipping cost regardless of destination using the shipping service provider.

7. The guaranteed shipping cost system of claim 1, wherein the estimated shipping cost computation engine is configured to generate a shipping label to be used with the shipping service provider.

8. The guaranteed shipping cost system of claim 1, wherein the shipping cost reconciliation module is configured to determine a difference between the estimated shipping cost and the actual shipping cost.

9. The guaranteed shipping cost system of claim 8, wherein the learning module is configured to increase the estimated shipping cost for the item by the difference between the estimated shipping cost and the actual shipping cost when the actual shipping cost is higher than the estimated shipping cost.

10. The guaranteed shipping cost system of claim 8, wherein the learning module is configured to decrease the estimated shipping cost for the item by the difference between the estimated shipping cost and the actual shipping cost when the actual shipping cost is less than the estimated shipping cost.

11. A method for a guaranteed shipping cost system comprising:
determining whether an item to be listed by a seller in an online marketplace qualifies for a guaranteed shipping cost listing;
computing an estimated shipping cost of the item;
reconciling an accrual of the estimated shipping cost received from the buyer with an actual shipping cost received from a shipping service provider for shipping the item; and
adjusting the estimated shipping cost computation module based on the reconciliation between the estimated shipping cost and the actual shipping cost.

12. The method of claim 11, further comprising:
generating a guaranteed shipping cost listing comprising a listing from the seller for the item with the estimated shipping cost of the item as a firm shipping cost of the item for the seller.

13. The method of claim 12, further comprising:
generating a financial transaction between the seller and a buyer for the item in the guaranteed shipping cost listing; and
accruing a first portion of the financial transaction for the estimated shipping cost, and accruing a second portion of the financial transaction for the seller.

14. The method of claim 11, further comprising:
qualifying the item for the guaranteed shipping cost listing if the item is listed in a list of items with predictable shipping costs without requesting a weight of the item from the seller.

15. The method of claim 11, further comprising:
computing the estimated shipping cost of the item based on a history of previous transactions involving the same item in the online marketplace.

16. The method of claim 11, further comprising:
computing the estimated shipping cost of the item as a flat shipping cost regardless of destination using the shipping service provider.

17. The method of claim 11, further comprising:
generating a shipping label to be used with the shipping service provider.

18. The method of claim 11, further comprising:
determining a difference between the estimated shipping cost and the actual shipping cost.

19. The method of claim 8, further comp sing:
increasing the estimated shipping cost for the item by the difference between the estimated shipping cost and the actual shipping cost when the actual shipping cost is higher than the estimated shipping cost; and
decreasing the estimated shipping cost for the item by the difference between the estimated shipping cost and the actual shipping cost when the actual shipping cost is less than the estimated shipping cost.

20. A non-transitory computer-readable storage medium storing a set of instructions that, when executed by a processor, cause the processor to perform operations, comprising:
determining whether an item to be listed by a seller in an online marketplace qualifies for a guaranteed shipping cost listing;
computing an estimated shipping cost of the item;
reconciling an accrual of the estimated shipping cost received from the buyer with an actual shipping cost received from a shipping service provider for shipping the item; and
adjusting the estimated shipping cost computation module based on the reconciliation between the estimated shipping cost and the actual shipping cost.
